(19) United States
(12) Patent Application Publication
(10) Pub. No.: US 2007/0289183 A1
(43) Pub. Date: Dec. 20, 2007

(54) Sign transportation ans storage device

(76) Inventor: Ananyzeth Gonzalez, Chula Vista, CA (US)

Correspondence Address: THE MAXHAM FIRM, 9330 SCRANTON ROAD, SUITE 350, SAN DIEGO, CA, 92121, US

(21) Appl. No.: 11/471,416

(22) Filed: Jun. 19, 2006

(51) Int. Cl. G09F 7/00

(52) U.S. Cl. 40/611.06

(57) ABSTRACT

A sign transportation and storage device which is generally a rectangular housing sized to receive through an open end a number of rectangular signs. The housing is formed with an opening on one side so that the image or graphics on the signs within the device may be easily seen and the top sign may be physically accessed by the user. Alternatively, a substantially transparent window may cover the opening to prevent the signs within the housing from being damaged. The housing is formed with a notch adjacent the open end to provide a gripping area for removing the sign and a retaining strap may be provided to extend over the open end of the housing to keep the signs securely in the storage device during storage and transportation. Carrying straps may be employed to facilitate carrying the sign transportation and storage device, and storage pouches may be provided for tools.

### BACKGROUND

1. Field of the Invention

The present invention relates generally to storage devices and is more particularly, though not exclusively, related to devices used for the safe storage and transportation of signage, particularly those signs used in the field of real estate.

2. Background Discussion

In the field of real estate, whether selling, leasing, or renting a property, the use of signs is typically the key to capturing the attention of passing customers. Nowhere is this more evident than in the real estate market where customers often simply drive around a neighborhood of interest looking for signs indicating residences or offices for rent or sale.

In order to maximize the impact a sign has on a potential customer, salespeople often create very elaborate, professional looking signage which gives an indication of the identity of the salesperson, the broker, the company offering the property, and the nature of the property. For instance, signage created for use by a real estate salesperson might identify the property of interest as residential or commercial, a condominium or single family residence, may perhaps state the size and configuration of the home or office (3 bedroom, 2 bath, 1400 square feet), or other identifying characteristics of interest. Often the signage set out in the neighborhood is the first thing a potential customer sees. As a result, a salesperson may create very expensive, quality signage in order to present the best possible first impression. This is particularly so when selling expensive property where the commissions on a single sale could reach tens of thousands of dollars. Alternatively, real estate signs could be more general and reusable, merely saying “OPEN HOUSE” for the simplest possible use. As a matter of fact, holding an open house is one of the main activities directly related to advertising real estate. And holding an open house may entail putting up many signs and spending money on signage.

Despite the significant investment in the creation of quality signage, many real estate agents have no practical manner for transporting and storing the signs. For instance, most real estate salespeople simply pile the signs in the trunk of their car, their garage, their client's garage, or in the office, while not in use. Unfortunately, because these signs are stacked on one another, subject to the constant movement of the car, and not secured in place, the signs often become scratched or broken, or tangled up, resulting in shabby-looking signage, and the eventual need to replace the damaged signs, at significant cost. Also, signs are installed on lawns or in dirt and in turn dirty up the area where they are kept or the vehicle used to transport the signs.

In an effort to overcome the challenges above, U.S. Pat. No. 4,765,381, which issued to Castle for an invention entitled “Sign Carrier and Storage Bag,” discloses a soft-sided pouch-like sign carrier. The Castle carrier was intended to carry a single sign, and although useful for preventing the destruction of that single sign, if more than one sign was stored in the Castle carrier, the two signs would tend to scratch against each other. Moreover, due to the flexible nature of the Castle carrier, the signs within the carrier were free to jostle about during transit and storage in a car. This jostling would produce much of the same damage created by simply tossing the signage into the trunk of the car. Moreover, the sign within the Castle carrier can be easily crushed or broken due to the flimsy structure of the carrier.

U.S. Pat. No. Des. 371,237, which issued to Pfeifer for an invention entitled “Tote Bag For Carrying and Storing A Real Estate Sign,” discloses another soft-sided bag used to storing and transporting signage. Like the Castle carrier discussed above, the Pfeifer device is flimsy and provides no protection to prevent a sign from being crushed or broken. Also, if more than one sign is placed in the Pfeifer device, the signs will tend to scratch against each other.

In an effort to store and transport multiple signs, a “Real Estate Sign System and Carrier Therefor” was disclosed by Valento in U.S. Pat. No. Des. 292,995. The Valento device consists of a wire rack equipped to hold multiple signs and support poles which can be easily removed for use. However, the Valento device is very bulky and only accommodates flexible signage. Further, because the device does not retain the signage or poles securely in place, the device is not easily portable, and cannot easily be transferred from vehicle to vehicle without damaging the signage.

In light of the above, it would be advantageous to provide a sign transportation and storage device, which provides for the convenient storage of signage in a vehicle, at the office or at home, and protects the signage from damage, thereby prolonging the life of the sign. In addition, it accommodates and facilitates the work involved when a real estate salesperson is coordinating the installation of open house signs. It would also be advantageous to provide a sign transportation and storage device which maintains multiple signs organized and in a constant, stable position, to avoid disorder and to prevent the loss of a sign or forgetting to retrieve all signs which were distributed. It would also be advantageous to provide a sign transportation and storage device which could be easily carried, would hold a number of signs and the tools necessary to install them, and which could be easily accessed, such as through a car window or door, to facilitate the quick installation and retrieval of the signs.

### SUMMARY OF THE INVENTION

The sign transportation and storage device of the present invention includes a rectangular housing that is sized to receive through an open end a number of rectangular signs, such as those signs typically used for the regional advertisement of available real estate or to announce an open house on a particular day. The housing is formed with a viewing cutout on one side so that the image or graphics on the signs within the device may be easily seen. The sign is physically accessible through the cutout so that it can easily be slid part way out the open end by the touch of a person's fingers. This is particularly advantageous when multiple sign transportation and storage devices are used, with each containing a different sign type, or signs for different purposes (for rent, for sale, for lease, among others). A rigid, but substantially transparent, window may cover the viewing cutout to prevent the signs within the housing from being damaged.

The housing is formed with a notch adjacent the open end to provide a gripping area that allows the user to easily grasp the grip portion of the sign for removal from the storage device. A retaining strap may be provided to extend over the open end of the housing to keep the signs securely in the storage device during storage and transportation. Also, a variety of carrying straps and handles may be provided to facilitate the carrying of the sign transportation and storage device. The device of this invention may also include storage pouches for tools to be used in the installation of the signs. These pouches are on the outside of the housing to avoid damaging the signs within the device, and to facilitate the access to those tools.

In one embodiment, the sign transportation and storage device may be formed with a series of channels within the housing which are sized to receive the signs, and maintain the signs in a specific channel thereby avoiding any contact between the several signs within the housing. This prevents the signs from scratching and damaging each other during the storage, transportation and use of the device.

### BRIEF DESCRIPTION OF THE DRAWING

The objects, features, and advantages of the method according to the invention will be more clearly perceived from the following detailed description, when read in conjunction with the accompanying drawing, in which:

FIG. 1 is a perspective view of the sign transportation and storage device of the present invention;

FIG. 2 is a perspective view of a typical sign used in conjunction with the device of FIG. 1;

FIG. 3 is a perspective view of the device of FIG. 1 showing the positioning of signs within the storage device;

FIG. 4 is a front view of the device of FIG. 1 showing multiple signs, with some partially out of the housing;

FIG. 5 is a perspective view of an alternative embodiment of the device of the present invention;

FIG. 6 is a representative sign from the housing as displayed in a typical manner;

FIG. 7 is a cross-sectional view of the sign transportation and storage device of the present invention as taken along line 7-7 of FIG. 3; and

FIG. 8 is a cross-sectional view of an alternative embodiment of the device of the present invention.

### DETAILED DESCRIPTION OF THE PREFERRED EMBODIMENTS

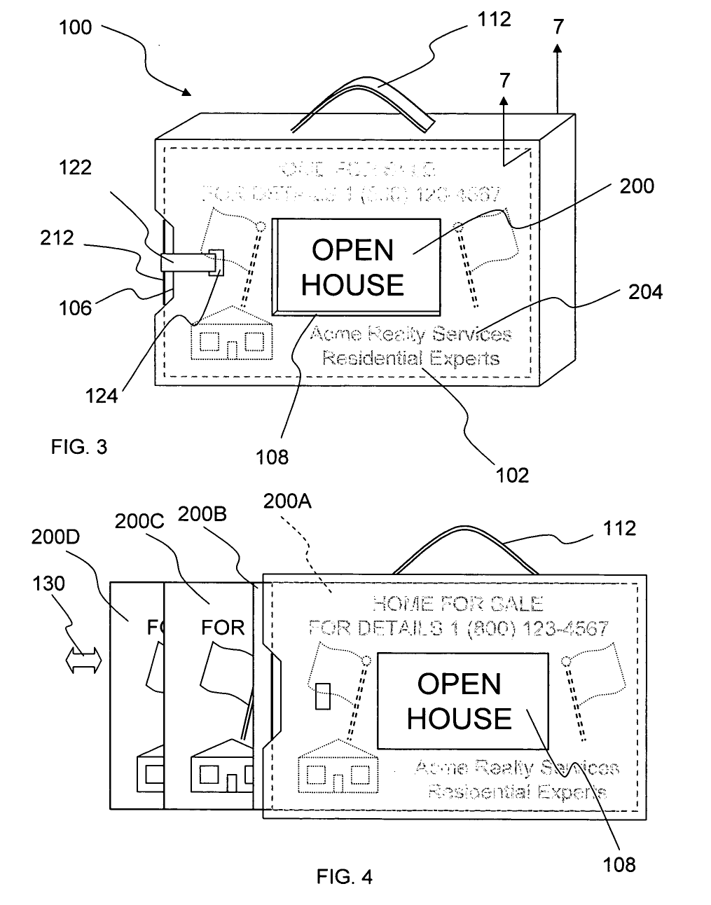

Referring initially to FIG. 1, a perspective view of the sign transportation and storage device of the present invention is shown and generally designated by the reference numeral 100. Sign transportation and storage device 100 includes rectangular housing 102 having open end 104. On the side wall adjacent the open end, notch 106 is formed to facilitate the removal of signs from within the housing, as will be described in greater detail in conjunction with FIG. 3.

Housing 102 is formed with opening 108 so that the signs within the housing may be viewed without having to remove the sign from the device. A window 110 may be provided which, in a preferred embodiment, would be an opening, permitting physical access to the interior of the housing. Alternatively, a substantially transparent material could be employed to cover opening 108 that would provide protection to the contents from scratches, yet allow an unobstructed view of a portion of the top sign. While opening 108 is shown in the middle of one broad side of housing 103, it need not be centrally located. Handle 112 may be provided to facilitate the transportation of the device.

In a preferred embodiment, the housing of the present invention will have a length 114 of approximately 25 inches, a height 116 of approximately 18½ inches, and a depth 118 of approximately 2¼ inches. It is to be appreciated, however, that the length, height, and depth are merely exemplary, and may vary in order to accommodate signs having different sizes, and the dimensions given here are for exemplary purposes only. Depth 118 may be less for a sign transportation and storage device intended to store five signs, and more for a device intended to store ten signs, for example.

Tool pouch 120 may be provided, if desired, on the outside of housing 102 for the convenient storage of tools necessary for the installation of any signage. For instance, hammers, screwdrivers, or other tools may be placed in the tool pouch for transporting along with the signs, and thereby be available for the installation and removal of the signs. The tool pouch is shown on one broad side of the housing, but it could be located as convenient on any panel, including an edge or an end of the housing.

In order to retain the signs within housing 102, a retaining strap 122 is provided which passes over the open end of the housing and attaches to fastener 124. Fastener 124 may be any appropriate type of fastener. For instance, a snap, buckle, or hook-and-loop fastener may be used. Once retaining strap 122 is attached to fastener 124, the signs are securely retained within the housing, and the device may be easily transported using carrying handle 112.

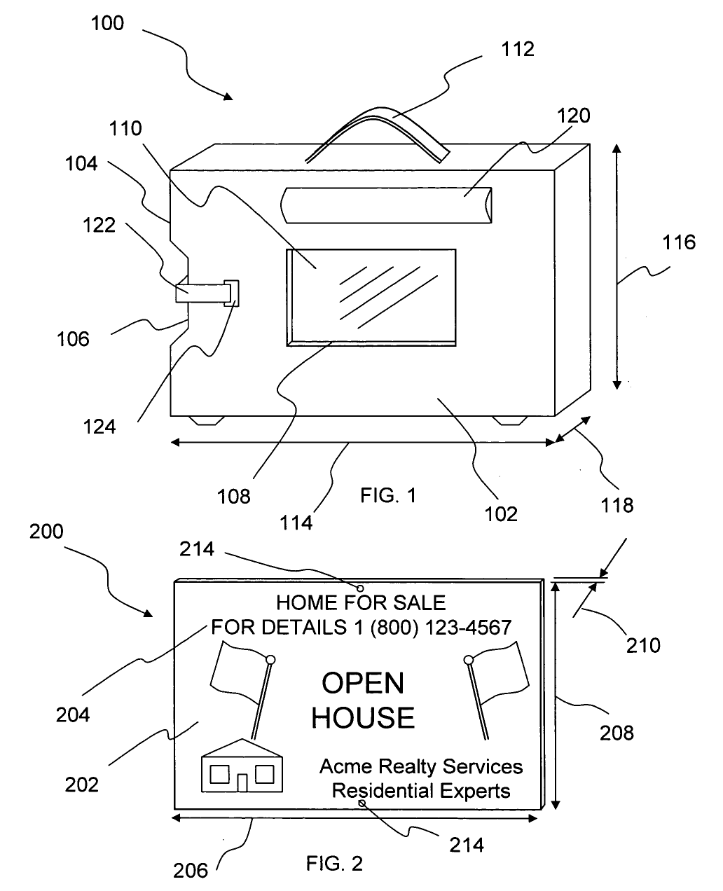

FIG. 2 provides a perspective view of a typical sign 200 used in conjunction with sign transportation and storage device 100 of the present invention. Sign 200 includes a sign panel 202 having a substantially rectangular shape, and is prepared with artwork 204, such as the identifying markings (for sale, for rent, for lease, among others). By way of example only, sign 200 has a width 206 of approximately 24 inches, a height 208 of approximately 18 inches, and a thickness 210 of approximately 3/16 inch. It is to be appreciated that the width 206 and height 208 of sign 200 will be slightly less than the length 114 and height 116 of housing 102. It is also to be appreciated that the depth 118 of housing 102 is typically sufficient to accept several signs having thickness 210. Sign 200 is optionally formed with holes 214 centered at the top and bottom to facilitate mounting the sign to a stake, pole, or other structure.

Referring now to FIG. 3, a perspective view of sign transportation and storage device 100 of the present invention is shown with signs 200 within housing 102 and retained in place with retaining strap 122. As shown in this figure, portions of artwork 204 on the sign are visible through opening 108, and other portions of the artwork remain protected within the housing. This hidden artwork is shown in phantom lines behind the front or top surface of the housing.

From FIG. 3, the cooperation between notch 106 and accessible end portion 212 of sign 200 is clearly shown. The notch adjacent open end 104 of the housing provides a convenient location from which a sign can be grasped and pulled from housing 102 for use.

FIG. 4 is a front view of sign transportation and storage device 100, showing multiple signs 200 partially in and partially out of housing 102. More specifically, housing 102 has been loaded with a plurality of signs 200A, 200B, 200C, and 200D. Each of these signs 200 can be separately inserted or removed in direction 130 by sliding a sign through open end 104 of housing 102. In use, the device 100 may be conveniently positioned in the front seat of a car, or in the trunk, and signs 200 may be dispensed from the housing 102 as needed for placement in the neighborhood adjacent a subject property. Opening 108 permits the top sign to be accessed by the agent's fingers and shoved out open end 104, after strap 122 is disengaged. This can be done easily by reaching into the vehicle through the open passenger side window, or by the agent from the driver's seat before exiting the vehicle. At the end of the day, the signs can be retrieved from the neighborhood, and returned to housing 102 for safekeeping. It is important that signs 200 be readily dispensable from housing 102 because when a salesperson is at a busy intersection it is imperative to be “prompt” in the installation process. This is particularly the case when posting signs at busy intersections where parking is not easily accessible and must be very short term.

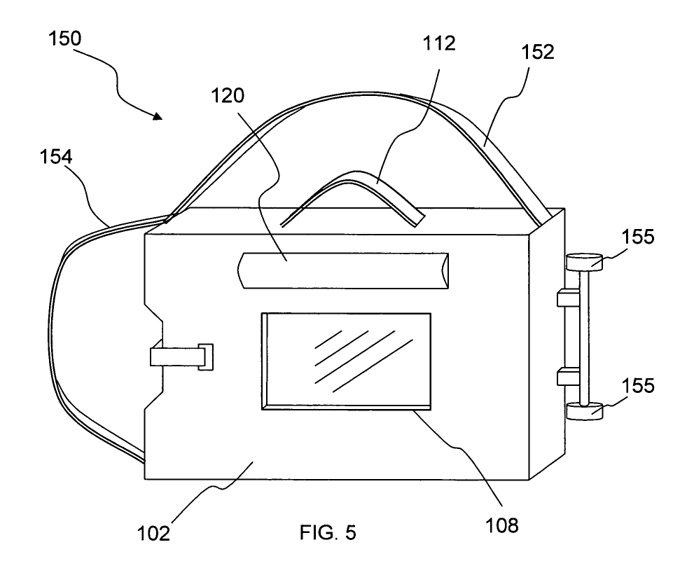

Referring now to FIG. 5, a perspective view of an alternative embodiment of the sign transportation and storage device of the present invention is shown and generally designated by reference numeral 150. Storage device 150 includes shoulder carrying straps 152 and 154. The shoulder straps facilitate the transportation of the device 100 when it is necessary to move it for any significant distance or in circumstances where the user must carry multiple items. It is to be appreciated that the particular shoulder straps 152 and 154 are merely exemplary of a preferred embodiment, and that the straps can be adjustable in length, may have different attachment points, and may be removable or interchangeable. It is also understood that one of the shoulder straps 152 and 154 may be used alone, and that if shoulder strap 154 is implemented, retaining strap 122 may be omitted as signs 200 will not exit housing 102 when device 100 is being carried in the upright position.

In order to facilitate the transport of device 100 for significant distances, a pair of rollers 155 may be mounted to housing 102. In use, the user may orient housing 102 so that rollers 155 are in contact with the ground, and housing can be rolled while grasping strap 154. This is particularly advantageous when signs 200 are made from heavy materials, or when having to travel significant distances.

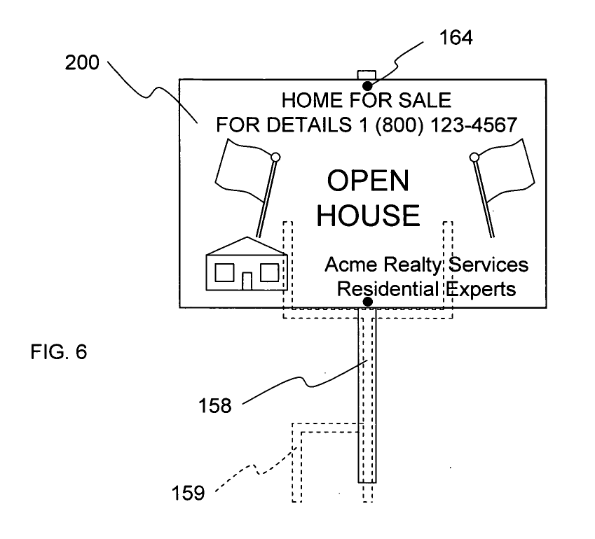

As shown in FIG. 6, attachment device 164 such as a pin, a bolt and nut, a screw, or other known appropriate element, may be used to temporarily retain sign 200 in position for display on a typical pole or stake 158. Holes 214, shown in FIG. 2, would be employed to receive device 164. At the end of the day, the attachment devices 164 may be removed and the sign 200 returned to housing 102. An alternative embodiment of stake 158 is shown as stake 159 in phantom, and it is to be appreciated that any stake used in the industry is compatible with the signage discussed herein.

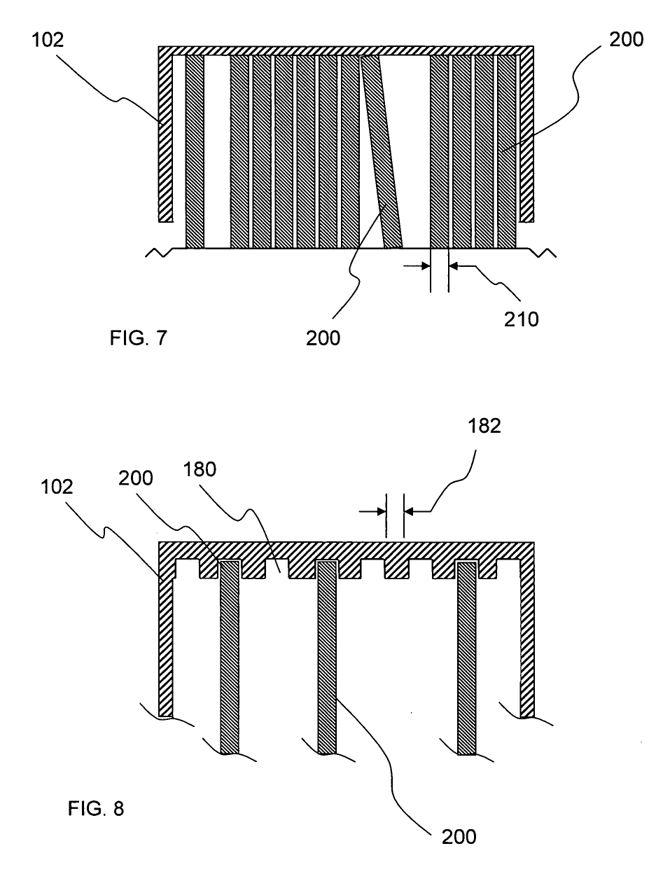

FIG. 7 is a cross-sectional view of the sign transportation and storage device of the present invention as taken along line 7-7 of FIG. 3. This view shows the placement of multiple signs 200 within housing 102, and provides clarification as to an exemplary relationship between depth 118 of housing 102, and thickness 210 of sign 200. Specifically, the housing 102 is intended to receive a plurality of signs 200, and retain those signs in a fixed relationship, thereby preventing damage to the signs caused by the sliding of the signs against each other, and possibly careless handling, as would typically occur if they were simply tossed individually into a car trunk.

As shown in FIG. 8, a cross-sectional view of an alternative embodiment of sign transportation and storage device 100 of the present invention is provided. This view shows housing 102 formed with a series of sign-receiving channels 180 separated by a gap 182 which prevents the signs 200 within the housing from coming into contact with other signs, thereby preventing any damage to the signs during storage and transportation, or during the insertion and removal of the signs from the storage device.

A key advantage of the sign transportation and storage device of the present invention is the ability to conveniently, easily, and properly transport and store very valuable signage. The device provides a secure, damage free storage housing that eliminates the typical causes of damage to signs. Also, because the device 100 has a fixed size, it is quickly apparent when a sign has been inadvertently forgotten. This is particularly advantageous when considering real estate signage. For a real estate open house, for example, a real estate agent travels to strategic locations throughout a neighborhood placing signage directing potential buyers to the property. Following a long day of making sales presentations to those potential buyers, the real estate agent is often tired, and in some cases, may not recall the exact number of signs, which were placed. By using the sign transportation and storage device of the present invention, a missing sign is readily noticed as there will be an open slot in housing 102 as shown in FIG. 8. This significantly reduces the likelihood that signs will be forgotten, and will decrease the loss of those signs.

While there have been shown what are presently considered to be preferred embodiments of the present invention, it will be apparent to those skilled in the art that various changes and modifications can be made herein without departing from the scope and spirit of the invention.

What is claimed is:

1. A sign transportation and storage device for receiving a plurality of signs, said device comprising:
a housing having an open end, said housing being generally rectangular and being configured to receive through said open end a plurality of said signs;
a fastener on said housing; and
a retaining strap extending from said housing over said open end and attachable to said fastener to retain said signs in said housing.

2. The device of claim 1, and further comprising an opening through one side of said housing to provide visible access to the top sign in said housing.

3. The device of claim 2, and further comprising a generally flat, substantially transparent, window element covering said opening.

4. The device of claim 1, wherein said housing is formed with a notch adjacent said open end.

5. The device of claim 1, and further comprising at least one carrying strap attached to said housing to facilitate carrying the device.

6. The device of claim 1, wherein said housing is rigid.

7. The device of claim 1, wherein said housing is formed with a plurality of interior channels, each channel being separated from an adjacent channel by a gap, each said channel being sized to receive one said sign.

8. The device of claim 1, and further comprising a tool storage pouch.

9. The device of claim 1, and further comprising a handle.

10. The device of claim 2, wherein said opening provides direct access to the top sign in said housing to enable it to be pushed out said open end of said housing.

11. A sign transportation and storage device, comprising:
a rigid, generally rectangular housing having an open end, said housing being configured to receive a plurality of signs through said open end, said housing being formed with an opening in one side thereof;
a carrying strap attached to said housing adjacent said open end; and
a retaining strap extending from said housing adjacent said open end and fastenable to said housing to retain said signs within said housing.

12. The device of claim 11, wherein said housing is formed with a plurality of channels sized to receive a sign, each said channel being separated from adjacent channels by a gap.

13. The device of claim 11, and further comprising a tool storage pouch.

14. The device of claim 11, and further comprising a handle.

15. The device of claim 11, and further comprising a notch formed in said housing adjacent said open end to provide gripping access to said signs in said housing.
